(19) United States
(12) Patent Application Publication
(10) Pub. No.: US 2024/0170232 A1
(43) Pub. Date: May 23, 2024

(54) PULSE-TRAIN LASER-PLASMA ACCELERATOR

(71) Applicants: ECOLE POLYTECHNIQUE, Palaiseau (FR); ECOLE NATIONALE SUPERIEURE DES TECHNIQUES AVANCEES, Palaiseau (FR); CENTRE NATIONAL DE LA RECHERCHE SCIENTIFIQUE, Paris (FR)

(72) Inventors: Igor ANDRIYASH, Paris (FR); Cédric THAURY, Montigny-le-Bretonneux (FR); Alessandro FLACCO, Montrouge (FR)

(21) Appl. No.: 18/551,791

(22) PCT Filed: Mar. 25, 2022
(86) PCT No.: PCT/EP2022/058016

§ 371 Date: Sep. 21, 2023

(30) Foreign Application Priority Data
Mar. 25, 2021 (FR) 2103036

(51) Int. Cl. H01H 1/54; H01H 15/00; H01S 3/00

(52) U.S. Cl. CPC H01H 1/54; H01H 15/00; H01S 3/0057

(57) ABSTRACT

A method for producing energetic electron beams using a laser-plasma accelerator including a laser and a device for producing a gas cloud in a vacuum chamber, the method including a step of generating a laser pulse which is focused into the gas cloud to create a plasma. The step of generating a laser pulse includes at least the generation of a laser pulse-train with a delay between two successive laser pulses of between three times and thirty times the plasma period TP, such that: TP=λp/c, λp being the plasma wavelength defined by: λp=(2π/C)*(n e2/(m ε0))−½, where c is the speed of light, n is the electron density of the plasma in cm3, e=1.6e−19 C is the charge of an electron, m=9.1e−31 kg is the mass of an electron, and ε0=8.85×10−12 m−3 kg−1 s4 A2 is the permittivity of vacuum.

### TECHNICAL FIELD

The present invention relates to a method for producing energetic electron beams by means of a laser-plasma accelerator. Such an accelerator comprises a laser and a device generating a gas cloud in a vacuum chamber.

### STATE OF THE ART

In general, laser-plasma accelerators make it possible to produce energetic electron beams by focusing an intense laser pulse into a gas cloud.

The laser-plasma accelerator uses a laser to create a wake wave in a plasma. This wave is formed by plasma electrons that are not accelerated. On the other hand, the wave generates an accelerator field in which other electrons are accelerated over very short distances up to very high energies.

In most of the acceleration regimes, the charge of the electron bunch increases in linear fashion with the laser energy, then saturates when this energy exceeds a certain threshold that depends on the conditions of interaction.

The document U.S. Pat. No. 5,637,966 A is known, describing the generation of a train of laser pulses with a pulse frequency optimized to have a resonant excitation of the plasma wave. The objective is to efficiently excite a plasma wave with low-energy pulses. However, the technique described is complex, as it needs to keep the pulse train resonant with the plasma wave over significant lengths.

The document by Meng Wen et al, “Generation of high charged energetic electrons by using multiparallel laser pulses”, PHYSICS OF PLASMAS 17, 103113 (2010), describes a method for generating laser pulses in parallel in order to obtain a large quantity of energetic electrons. The method described in this document is difficult to implement. It is necessary in particular to use fragile and expensive phase plates that only operate for a given configuration without the possibility of adjustment. The different laser beams must be separated by quite a substantial distance in order to prevent them from merging during their propagation in the laser. As a result, the overall electron source size is large.

The document by Paolo Tomassini et al, “The resonant multi-pulse ionization injection”, PHYSICS OF PLASMAS 24, 103120 (2017), describes generating a train of resonant ultra-short pulses. This relates to a technique for trapping high-quality electrons in the plasma wave. This technique is very complex to implement.

The document by Craig W. Siders et al, “Efficient high-energy pulse-train generation using a 2n-pulse Michelson interferometer”—APPLIED OPTICS 22, 5302-5305 (1998), is also known, which describes an ultrafast multiplexer making it possible to generate high-energy pulse trains. The spaces between the pulses in the pulse train can be adjusted. This is a technique for generating multiple pulses. It can be complex to implement since it changes the polarization state of the laser.

The purpose of the invention is to increase the charge of the accelerated electron beams in the laser-plasma accelerators.

Another purpose of the invention is a novel accelerator using a lower-power laser for a level of charge equivalent to the current systems.

A further purpose of the invention is to propose an improvement that is simple to implement and inexpensive.

### DISCLOSURE OF THE INVENTION

At least one of the aforementioned objectives is achieved with a method for producing energetic electron beams by means of a laser-plasma accelerator comprising a laser and a device for generating a gas cloud in a vacuum chamber, the method comprising a step of generating at least one laser pulse that is focused into the gas cloud so as to create a plasma. According to the invention, the step of generating at least one laser pulse comprises at least generating a laser pulse train with a delay between two successive laser pulses comprised between three times and thirty times the plasma period Tₚ, such that:

Tₚ=λₚ/c

λₚ being the plasma wavelength defined by: λₚ=(2π/c)*(n e₂/(m ε₀))^{-1/2}, where c is the light celerity, n is the plasma electron density in cm⁻³, e=1.6 e−19 C is the electron charge, m=9.1 e−31 kg is the electron mass, and ε₀=8.85×10⁻¹² m⁻³ kg⁻¹ s⁴ A² is the vacuum permittivity.

The method according to the invention can for example be implemented by using a processing unit for controlling the laser and different components.

Advantageously the plasma wavelength defined by λₚ=(2π/c)*(n e²/(m ε₀))^{-1/2} can be estimated with the formula λₚ˜3.3 n^{-1/2} 10⁴ m.

The gas cloud can originate from a gas jet, from gas-filled cells or any other device capable of generating a gas cloud in a space under vacuum.

With the method according to the invention, a pulse train is used in place of a single laser pulse. Each pulse accelerates electrons in its wake, so that a train of electron bunches is produced.

It is then possible to envisage a linear function in which the electron charge increases in linear fashion with the laser energy. This makes it possible to increase the efficiency of the laser-plasma accelerators, in particular for applications in radiobiology, or industrial radiography.

A regime can also be envisaged where the charge does not vary in linear fashion with the energy. In this case, it is possible to work at constant laser energy determined to give the best efficiency, i.e. a condition in which the percentage of energy transferred from the laser to the electrons having the desired characteristics is maximum.

In fact, it is not always appropriate to maximize the total charge. For certain applications, it is necessary to maximize the charge below 10 MeV. The energy maximizing the charge at 10 MeV per laser Joule will be different from that maximizing the charge at 100 MeV.

The present invention is noteworthy in particular for the fact that the technique defined is less sensitive to the space charge. This is an important criterion for applications combining high charge and low energy. In this case, on leaving the accelerator the electrons repel one another, and their divergence can increase very significantly, which can be problematic for their use. By stretching the electrons over time as in the present invention, the impact of this phenomenon is significantly reduced.

The inventors discovered that by separating the laser pulses by a duration comprised between three times and thirty times the plasma period, a maximum of electrons is trapped in the ionic cavities formed in the wake of the laser pulse.

In other words, by focusing separate laser pulses according to the invention into a gas cloud, the first pulse ionizes the gas and forms a wake wave in which electrons are trapped and accelerated. The second pulse forms a second wake where a new electron bunch is trapped and accelerated, and so on and so forth.

With the method according to the invention, a laser-plasma acceleration is obtained providing a laser that is inexpensive and small-sized, since the power can be lower than for the lasers of the prior art. The installation can be compact with the possibility of producing electron beams and X-rays from 1 to 200 MeV.

The method according to the invention proposes an improvement that is simple to implement and makes it possible to significantly improve the performance of the laser-plasma accelerators for radiography and therefore to reduce their cost. An increase in the electron charge by a factor of two almost halves the cost of the laser, which is the most expensive element of a laser-plasma accelerator.

According to an advantageous characteristic of the invention, the duration of each pulse can be comprised between 5 femtoseconds and 100 femtoseconds.

According to an embodiment, the total number of pulses in the laser pulse train can be comprised between 2 and 200, or between 2 and 100 or ideally between 2 and 40. The range of 2 to 40 pulses, or even 2 to 30 pulses, ensures that there are still ions close to the optical axis. Further on, the ions start to move away significantly from the optical axis due to a radial acceleration by charge separation. In other words, each laser pulse moves the electrons away from the optical axis. These electrons are then brought back towards the optical axis by the ions and oscillate. On average, there are more ions on the optical axis and more electrons around the optical axis. This generates an electric field that accelerates the ions towards the sides.

Beyond 40 pulses, it is possible to envisage for example an operation with low peak power with pulses of a few femtoseconds.

Advantageously, the total laser energy at output of the laser can be comprised between 100 mJ and 20 J. The laser used can generate a beam with lower energy than the energy of the lasers of the prior art. In fact, the repetition of the pulses according to the invention makes it possible to increase the overall charge of the electrons.

According to the invention, the energy per laser pulse can be comprised between 25 mJ and 2 J. In this energy range, in most cases, the energy threshold capable of saturating the charge of the electron bunch is not exceeded.

According to an advantageous characteristic of the invention, the laser can emit a laser beam having a wavelength of 800 nm. For such a wavelength, it is possible for example to use a Ti:sapphire laser, but other wavelengths such as in the visible or near infrared can be envisaged.

Advantageously, all the laser pulses can have one and the same wavelength or different wavelengths comprising one wavelength and harmonics. In other words, it is possible to use a pulse at a given wavelength and other pulses at harmonic wavelengths of said given wavelength. By way of example, it is possible to envisage an alternation of pulses at w and 2 w, or a complete train at 2 w.

According to a characteristic of the invention, the laser beam can be focused so that each pulse of the laser pulse train reaches an illuminance greater than 10¹⁷ Wcm⁻² in the gas cloud. Such an intensity ensures that each pulse efficiently excites only one plasma wave.

Advantageously, the gas can comprise one or a mixture of the following gases: He, H2, Ar, N2. Other gases can be used.

According to the invention, the plasma electron density n can be comprised between 10¹⁸ cm⁻³ and 10²¹ cm⁻³, preferably between 5×10¹⁸ cm⁻³ and 5×10¹⁹ cm⁻³. The electron density is defined as being the number of free electrons per cm³, after ionization of the gas. For helium for example, this corresponds to the density of the gas, for H2 to twice the density of the gas, etc.

Advantageously, the gas cloud is produced either continuously, or in pulsed fashion at the frequency of the laser pulses.

More specifically, the gas cloud can be emitted in pulsed fashion at the frequency of the laser pulses with an opening duration greater than 1 ms.

According to an advantageous characteristic of the invention, the plasma length can be comprised between 0.02 mm and 100 mm, preferably between 0.1 mm and 3 mm.

According to another aspect of the invention, a laser-plasma accelerator is proposed for producing energetic electron beams by implementing a method such as described above: the laser-plasma accelerator comprising:
a laser for emitting a laser beam,
a laser compressor,
a splitter of the laser beam into a pulse train,
a device for producing a gas cloud in a vacuum chamber,
focusing optics.

According to the invention, said laser can be a laser incorporating the chirped pulse amplification (CPA) technique. The principle of the CPA technique is to stretch a laser pulse before amplification. Thus the different components of the laser pulse are delayed with respect to one another and pass in turn into the amplifying medium. Once all the frequencies have been amplified, the pulse is recombined, thus restoring to it the total power of each of the frequencies.

### BRIEF DESCRIPTION OF THE DRAWINGS

Other advantages and features of the invention will become apparent on reading the detailed description of implementations and embodiments that are in no way limitative, and from the following attached drawings.

FIG. 1 is a diagrammatic general view of a laser-plasma accelerator according to the invention:

FIG. 2 is a diagrammatic view of a gas cloud passed through by a laser pulse train according to the invention:

FIG. 3 is a diagrammatic view of a plasma wave formed after a laser pulse according to the invention:

FIG. 4 is a graphical representation illustrating an ionic cavity produced following a laser pulse according to the invention.

### DETAILED DESCRIPTION OF THE FIGURES

The embodiments that will be described hereinafter are in no way limitative: it is possible in particular to implement variants of the invention comprising only a selection of characteristics described hereinafter, in isolation from the other characteristics described, if this selection of characteristics is sufficient to confer a technical advantage or to differentiate the invention with respect to the state of the prior art. This selection comprises at least one, preferably functional, characteristic without structural details, or with only a part of the structural details if this part alone is sufficient to provide a technical advantage or to differentiate the invention with respect to the state of the prior art.

In particular, all the variants and all the embodiments described are intended to be combined together in all the combinations where there is no objection thereto from a technical point of view.

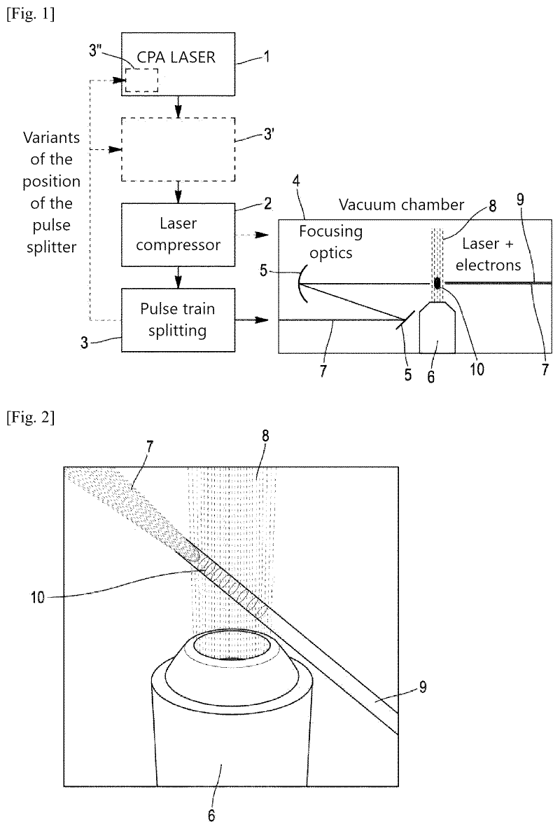

FIG. 1 shows a CPA laser 1 emitting at 800 nm with an energy of 1 J. This laser is provided to emit an initial laser pulse with a duration of 30 fs. A laser compressor 2 compresses this initial laser pulse before feeding a splitter 3 that generates a train of 8 pulses each having an energy of the order of 125 mJ. In other words, at each initial laser pulse, this pulse is divided into several pulses so as to constitute a pulse train according to the invention. The objective is to reduce the energy for each pulse of the pulse train and to multiply the number of laser pulses that accelerate electrons in their wake.

The splitter 3 can be placed downstream of the laser compressor 2 as shown in FIG. 1 or upstream as shown by the dashed-line frame 3′ in FIG. 1. It is also possible to envisage the use of a laser capable of generating femtosecond pulses at desired energy levels. Such a laser can be considered as incorporating a pulse train splitter as shown by the dotted line frame 3″.

FIG. 1 also shows a vacuum chamber 4 in which are arranged an optical focusing assembly 5 and a gas injector 6.

The gas injector 6 is capable of producing a gas cloud 8, such as helium, along for example a vertical axis inside the vacuum chamber.

The optical focusing assembly 5 comprises two mirrors the arrangement of which makes it possible to guide and focus the pulse train 7 originating from the laser-compressor-splitter assembly into the gas jet 8. Ideally, the pulse train 7 passes through the gas cloud 8 at a right angle but other arrangements making it possible to have different angles may be envisaged. In particular, the pulse train 7 can come into collision with the gas cloud 8 at an oblique angle so as for example to increase the distance travelled by the pulse train 7 in the gas cloud 8.

Furthermore, the cross section of the gas cloud 8 can have different shapes such as circular, rectangular, square, oval, elliptical, etc.

The laser-compressor-splitter assembly is configured so that the intensity of each pulse reaching the gas cloud 8 is equal to or greater than 10¹⁷ Wcm−2. For each pulse train, the gas is ionized by the rising edge of the first pulse of the train. Then, all the other laser pulses of the train directly see a plasma. Each pulse train encounters a new gas cloud, for example every s, 10 ms, or 100 ms, etc. according to the cadence.

On leaving the gas, the pulse train 7 as well as an electron beam 9 originating from the gas cloud, are encountered.

FIG. 2 shows the injector 6 diffusing a gas cloud having a circular cross section along a vertical axis. The pulse train 7 passes through the gas cloud 8, creating electron bunches that accompany the passage of the pulse train and are transformed into an electron beam 9 on leaving the gas cloud.

The plasma electron density can be calculated or estimated as a function of the gas used. In the case in point, in the example described using helium, the plasma electron density is of the order of 2 e19 cm⁻³. The plasma period TP can thus be calculated, such that:

Tₚ=λₚ/c

λₚ being the plasma wavelength defined by: λₚ=(2π/c)*(n e²/(m ε₀))^{-1/2}, where c is the light celerity, n is the plasma electron density in cm⁻³, e=1.6 e−19 C is the electron charge, m=9.1 e−31 kg is the electron mass, and ε₀=8.85×10⁻¹² m⁻³ kg⁻¹ s⁴ A² is the vacuum permittivity.

The invention is noteworthy in particular in that the frequency of the pulses in the pulse train is comprised between three times and thirty times the plasma period. With a frequency defined within this interval, the successive pulses in the pulse train make it possible to produce energetic electron beams with a maximum of electrons.

With the system according to the invention, as a function of the application concerned, it is possible to define an optimum laser energy making it possible to produce electrons having characteristics necessary for the application concerned. This laser energy is optimum, since it makes it possible to produce these electrons in the most efficient manner per laser Joule. For example, it differs if the production of electrons at 5 MeV or at 100 MeV is concerned.

For example in industrial radiography, the accelerator according to the invention makes it possible to easily control the electron beam generated, while maintaining an average energy of approximately 4 MeV.

Unlike the prior art, rather than a single high-energy pulse, a pulse train is used, with a delay between two pulses of the order of approximately one hundred femtoseconds for example. Each pulse accelerates electrons in its wake so that a train of electron bunches is created.

Each laser pulse creates a plasma wave constituted by several ionic cavities.

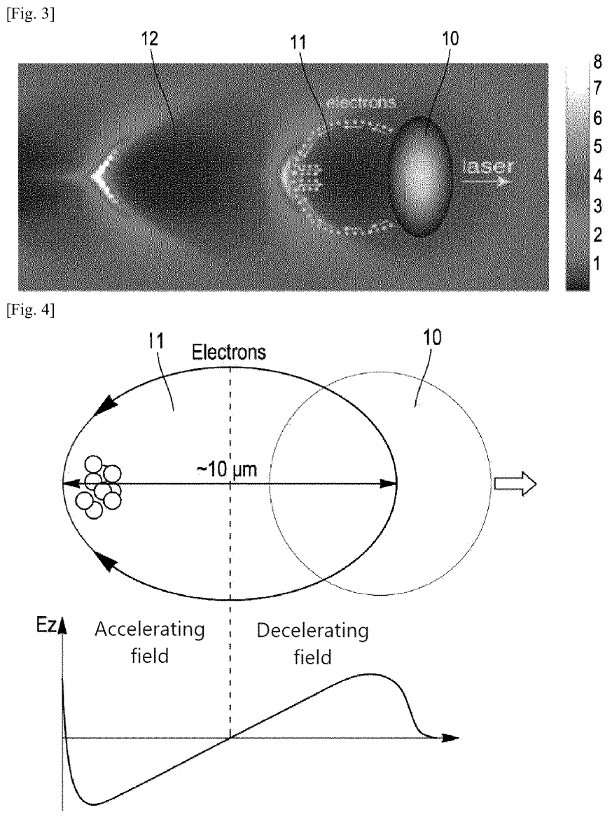

FIG. 3 illustrates such a plasma wave in which the laser pulse 10, a first ionic cavity 11 and a second ionic cavity 12 can be seen in the wake of the laser pulse 10. The accelerated electrons are inside, close to the optical axis. Initially they are injected at the rear, then advance towards the front during acceleration. In some cases, electrons are injected continuously: they can then eventually occupy all of the optical axis inside the ionic cavity. For each ionic cavity, a ponderomotive force expels the electrons from the optical axis.

FIG. 4 shows the ionic cavity 11 formed in the wake of the pulse 10. This is for example an ellipsoid elongated in the direction of propagation. Part of the ionic cavity overlaps with a rear part of the pulse. In the example in FIG. 4, most of the ionic cavity extends outside the pulse. The backward or forward direction is defined as a function of the direction of propagation of the laser pulse.

This ionic cavity is the site of competition between two electric fields. A decelerating electric field is present at the front of the ionic cavity in the zone of overlap with a part of the pulse. An accelerating electric field is present at the rear within the cavity and accelerates the electrons.

The electrons that form the ionic cavity are not the same over time: at each instant new electrons form the ionic cavity. They do not follow the laser pulse.

In certain cases, electrons that form the cavity gain enough energy to be injected at the rear, as illustrated in FIG. 4. This is not always the case, in particular when Ar or N2 are used, or a mixture containing one of these gases. In this case, it is core electrons of these atoms that are extracted from the ions and injected directly into the ionic cavity.

Typically, the ionic cavity 11 in FIG. 4 has a diameter along the axis of propagation of approximately 10 μm.

Thus in the present invention there is proposed a pulse train, with a delay of the order of approximately one hundred femtoseconds between two successive pulses. Each pulse accelerates electrons in its wake, so that a train of electron bunches is produced.

Of course, the invention is not limited to the examples that have just been described and numerous modifications may be made to these examples without departing from the scope of the invention.

1. A method for producing energetic electron beams by means of a laser-plasma accelerator comprising a laser and a device for generating a gas cloud in a vacuum chamber, the method comprising: a step of generating at least one laser pulse that is focused into the gas cloud so as to create a plasma: generating at least one laser pulse including at least generating a laser pulse train with a delay between two successive laser pulses comprised between three times and thirty times the plasma period Tₚ, such that:
Tₚ=λₚ/c
λₚ being the plasma wavelength defined by: λₚ=(2π/c)*(ne²/(mε₀))^{-1/2}, where c is the light celerity, n is the plasma electron density in cm⁻³, e=1.6 e−19 C is the electron charge, m=9.1 e−31 kg is the electron mass, and ε₀=8.85×10⁻¹² m⁻³ kg⁻¹ s⁴ A² is the vacuum permittivity.

2. The method according to claim 1, characterized in that the duration of each pulse is comprised between 5 femtoseconds and 100 femtoseconds.

3. The method according to claim 1, characterized in that the total number of pulses in the laser pulse train is comprised between 2 and 200.

4. The method according to claim 1, characterized in that the total laser energy is comprised between 100 mJ and 20 J.

5. The method according to claim 1, characterized in that the energy per laser pulse is comprised between 25 mJ and 2 J.

6. The method according to claim 1, characterized in that the laser emits a laser beam having a wavelength of 800 nm.

7. The method according to claim 1, characterized in that all the laser pulses have one and the same wavelength or different wavelengths comprising a wavelength and harmonics.

8. The method according to claim 1, characterized in that the laser beam is focused so that each pulse of the laser pulse train reaches an illumination greater than 10¹⁸ Wcm⁻² in the gas cloud.

9. The method according to claim 1, characterized in that the gas comprises one or a mixture of the following gases: He, H2, Ar, N2.

10. The method according to claim 1, characterized in that the plasma electron density n is comprised between 10¹⁸ cm⁻³ and 10²¹ cm⁻³.

11. The method according to claim 1, characterized in that the gas cloud is produced either continuously or in pulsed fashion at the frequency of the laser pulses.

12. The method according to claim 11, characterized in that the gas cloud is emitted in pulsed fashion at the frequency of the laser pulses with an opening duration greater than 1 ms.

13. The method according to claim 1, characterized in that the plasma length is comprised between 0.02 mm and 100 mm.

14. A laser-plasma accelerator for producing energetic electron beams by implementing athe method according to claim 1; the laser-plasma accelerator comprising:
a laser for emitting a laser beam;
a laser compressor;
a splitter of the laser beam into a pulse train;
a device for producing a gas cloud in a vacuum chamber; and
focusing optics.

15. The laser-plasma accelerator according to claim 14, characterized in that said laser is a laser incorporating the chirped pulse amplification technique (CPA).
